(19) United States
(12) Patent Application Publication
(10) Pub. No.: US 2018/0295469 A1
(43) Pub. Date: Oct. 11, 2018

(54) METHOD, APPARATUS AND SYSTEM FOR DESTINATION RECOMMENDATION AND SELECTION

(71) Applicant: NOKIA SOLUTIONS AND NETWORKS OY, Espoo (FI)

(72) Inventors: John HARRIS, Whitefish Bay, WI (US); Brian MOORE, Palatine, IL (US); Umamaheswar KAKINADA, Carpentersville, IL (US); Paul STEPHENS, Long Grove, IL (US)

(21) Appl. No.: 15/762,225

(22) PCT Filed: Sep. 16, 2016
(86) PCT No.: PCT/EP2016/071914

§ 371 Date: Mar. 22, 2018

Related U.S. Application Data
(60) Provisional application No. 62/221,289, filed on Sep. 21, 2015.

(51) Int. Cl. H04W 4/02; H04W 4/029; H04L 29/08; H04W 24/10; G06Q 30/02; G01C 21/34; G01C 21/36

(52) U.S. Cl. CPC H04W 4/023; H04W 4/029; H04L 67/18; G01C 21/3679; G06Q 30/0282; G01C 21/3461; G01C 21/3617; H04W 24/10

(57) ABSTRACT

A method includes, at a first server, determining a first potential destination and a second potential destination. The method further includes, at a second server, determining a first network performance metric corresponding to the first potential destination, and at the second server, determining a second network performance metric corresponding to the second potential destination. The method also further includes, at a third server, ranking the first potential destination and the second potential destination, wherein the ranking is based on a comparison between the first network performance metric and the second network performance metric.

### CROSS REFERENCE TO RELATED APPLICATIONS

This application claims priority from U.S. Provisional Application No. 62/221,289, filed on Sep. 21, 2015. The entire contents of this earlier filed application are hereby incorporated by reference in their entirety.

### FIELD

The present disclosure relates generally to the field of destination recommendation and more particularly to a method, apparatus and system for destination recommendation based in part on network performance.

### BACKGROUND

Destination recommendation algorithms are generally known in the telecommunications industry, and are designed to steer cellular subscribers/consumers toward locations and services based on, for example, subscriber preference, subscriber location, and proximity to a preferred location.

As the number of cellular subscribers increases, the need for improved wireless performance also becomes more important, as subscribers/consumers are utilizing not only wireless mobile phones, but also tablets, portable computers, and vehicle functionalities that require wireless services to properly perform.

### SUMMARY

A method includes, at a first server, determining a first potential destination and a second potential destination. The method further includes, at a second server, determining a first network performance metric corresponding to the first potential destination, and at the second server, determining a second network performance metric corresponding to the second potential destination. The method also further includes, at a third server, ranking the first potential destination and the second potential destination, wherein the ranking is based on a comparison between the first network performance metric and the second network performance metric.

A system includes at least one device having a memory, a processor, and a display, the device connected to a network, a first server configured for communicating with the device, a second server configured for communicating with the device, and a third server in communication with the first server and the second server. The third server is configured to receive a first potential destination and a second potential destination from the first server; receive a first network performance metric from the second server, the first network performance metric corresponding to the first potential destination; receive a second network performance metric from the second server, the second network performance metric corresponding to the second potential destination; and rank the first potential destination relative to the second potential destination, based on a comparison between the first network performance metric and the second network performance metric.

An apparatus includes a memory, a processor, and at least one database. The apparatus is in communication with a subscriber device, a first server and a second server. Further, the apparatus is configured to receive a first potential destination and a second potential destination from the first server, receive a first network performance metric from the second server, the first network performance metric corresponding to the first potential destination; receive a second network performance metric from the second server, the second network performance metric corresponding to the second potential destination; and rank the first potential destination relative to the second potential destination, based on a comparison between the first network performance metric and the second network performance metric.

### BRIEF DESCRIPTION OF THE DRAWINGS

To aid in the proper understanding of the present disclosure, reference should be made to the accompanying drawings, wherein:

FIG. 1 is a system diagram in accordance with an embodiment of the present disclosure;

FIG. 2 is a flow diagram illustrating a method in accordance with an embodiment of the present disclosure;

FIG. 3 is a diagram illustrating an example use case in accordance with an embodiment of the present disclosure;

FIG. 4 is a diagram illustrating an example use case in accordance with an embodiment of the present disclosure;

FIG. 5 is a diagram illustrating an example use case in accordance with an embodiment of the present disclosure;

FIG. 6 is a diagram illustrating an example use case in accordance with an embodiment of the present disclosure;

FIG. 7 is a diagram illustrating an example use case in accordance with an embodiment of the present disclosure; and

FIG. 8 is a diagram illustrating an apparatus in accordance with an embodiment of the present disclosure.

### DETAILED DESCRIPTION

Destination recommendation and selection services are increasingly utilized by consumers when navigating to a desired location. With the advent of customer-feedback driven applications such as Yelp!®, Google®, and TripAdvisor®, for example, consumers can select their desired destination based on more than just a proximity to their current location. The availability of wireless services at a user's desired location is also becoming more important to today's consumers, as the usage of wireless devices outside of the home/office has greatly increased in recent years. Accordingly, in some cases it can benefit a business and/or municipalities profits if they can offer improved wireless services. In addition, as more vehicles are now offering connected car services (such as navigation features and in-car applications like Pandora® and Slacker®, for example), wireless network performance is also becoming important for consumers while they are traveling to a desired location.

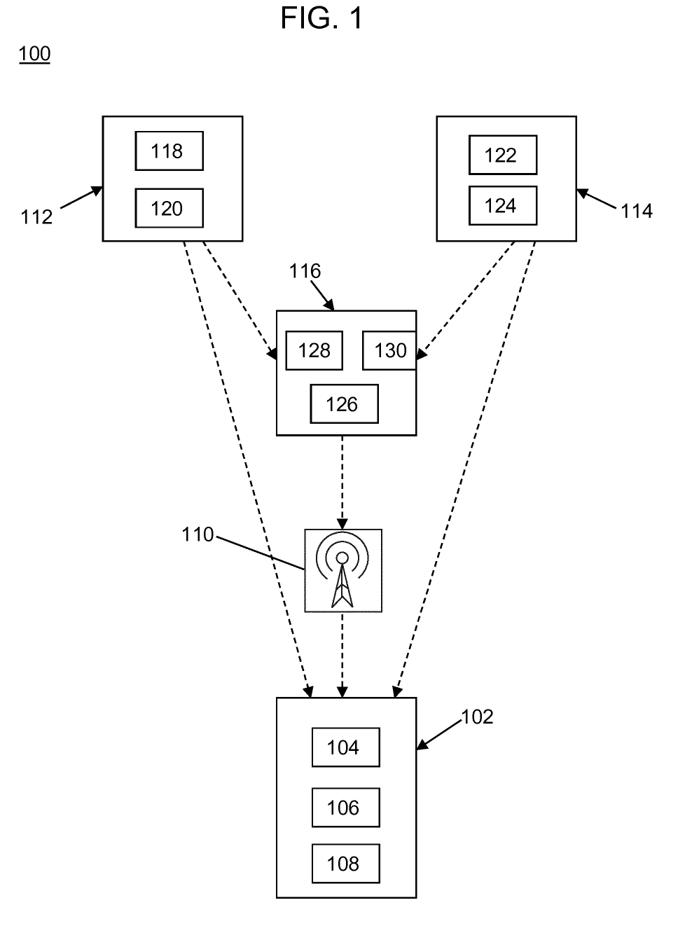

The present disclosure addresses the above issues and provides a system, method, and apparatus for destination recommendation and selection. Referring to FIG. 1, the present disclosure provides a system 100 that includes at least one device 102 having a memory 104, a processor 106, and a display 108, the device connected to a network 110. Although other options may be possible, in the present disclosure, the device 102 can be a mobile device, a vehicle, or a wearable accessory having a network connection, for example. The system 100 also includes a first server 112 configured for communicating with the device 102, a second server 114 configured for communicating with the device, and a third server 116 in communication with the first server and the second server.

The first, second, and third servers 112-116, respectively, can be standalone servers or a component within the network 110, as known by those having skill in the art. In one embodiment, the first and second and third server may reside within the wireless subscriber device. In a further embodiment, the subscriber device may determine the network performance attributes associated with at least the first and second potential destination based upon wireless messaging received over at least one cellular system. In a further embodiment, this messaging may comprise wireless messages being transmitted from a neighboring cell. In accordance with the present disclosure, the first server 112 can be a navigation server having a memory 118 and a processor 120. The navigation server can be configured for providing and storing GPS data, providing and storing navigation data, and providing and storing routing data relative to the first potential destination and the second potential destination. As known in the art, the data can be stored in a database in the memory of the navigation server, for example.

The second server 114 can be a network knowledge server having a memory 122 and a processor 124, and can be configured for providing and storing network performance metrics to the third server 116. For example, the network performance metrics can be stored in a database in the memory of the network knowledge server, as known by those having skill in the art. In the present disclosure, the third server 116 can be a correlation server having a memory 126, at least one database 128, and a processor 130. As will be described in further detail below, the correlation server is configured to rank the first potential destination and the second potential destination, to store the ranking, and to recommend a higher ranked one of the first potential destination and the second potential destination.

As will be described in further detail below, the third server 116 is configured to receive a first potential destination and a second potential destination from the first server 112. For example, the first potential destination and the second destination can be one of a merchant, a parking spot, a service provider, and a retail location. The first and second potential destinations can include wireless services, such as a video viewing capability, a security level above a predetermined threshold, and a preferred service provider. The predetermined threshold for the security level and the preferred service provider can be set by a user/subscriber of the device, or by the service provider, for example.

The third server 116 is further configured to receive a first network performance metric from the second server 114, the first network performance metric corresponding to the first potential destination. The third server 116 can then receive a second network performance metric from the second server 114, the second network performance metric corresponding to the second potential destination. The first network performance metric of the first potential destination and the second network performance metric of the second potential destination can be greater than a predetermined network performance metric threshold, which can be determined by the device user or the service provider, for example.

The third server 116 is then configured to rank the first potential destination relative to the second potential destination, based on a comparison between the first network performance metric and the second network performance metric. Once the correlation server 116 ranks the first potential destination and the second potential destination, it can automatically select one of the first potential destination and the second potential destination, and instruct the second server to navigate the device to the selected destination. Alternatively, the correlation server 116 can send the ranked first and second potential destinations to the second server 114, which can then communicate with the device 102. The user of the device 102 can then select one of the first or second potential destination, or can start a new search, for example.

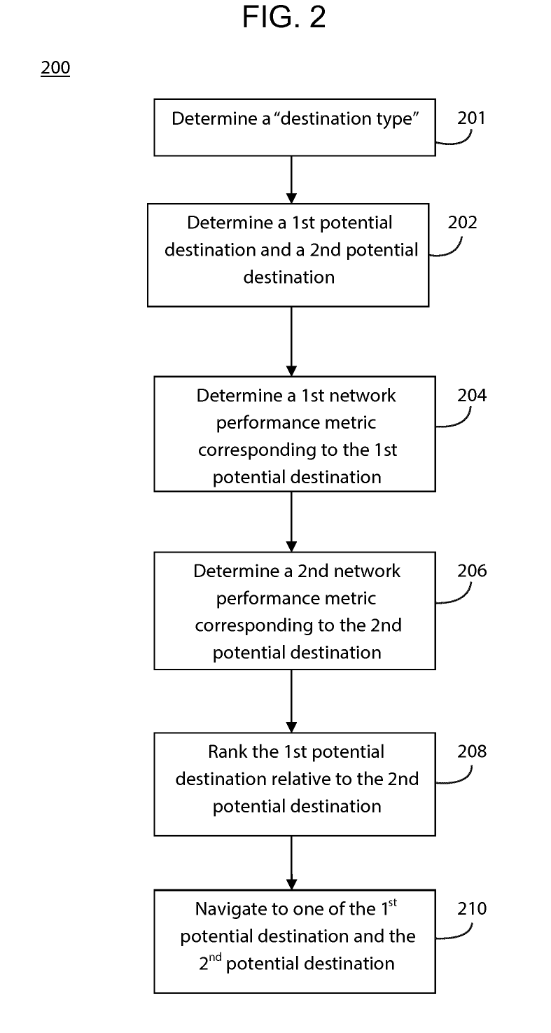

FIG. 2 illustrates a method 200 in accordance with the system 100. The method 200 is configured to be performed within a telecommunications network providing wireless services. At 202, the first or navigation server 112 determines a first potential destination and a second potential destination. The determining of the first potential destination and the second potential destination can be based on a previously determined “destination type”, for example (see step 201). Specifically, the user could indicate (on the device display, for example) that they wish to navigate to a coffee shop within town “A”. Similarly, the user can select the first potential destination and the second potential destination at the device display. Alternatively, the first or navigation server 112 could select the first and second potential destinations based on the destination type selected by the user.

At 204, the second or network knowledge server 114 determines a first network performance metric corresponding to the first potential destination. The second server 114 then determines a second network performance metric corresponding to the second potential destination (step 206). The first and second network performance metrics related to the first potential destination and the second potential destination, respectively, could include, for example, at least one of: an anticipated data rate; a network performance level along a route to the destination; a coverage level for a particular service; a network performance level at the destination; and a support level measurement for vehicle-to-Internet (V2I) notifications. The first and second network performance metrics could also correspond to businesses in the vicinity of the potential destination, and/or to the municipality in which the destination is located. However, it is understood that the first and second performance metrics are not limited to the above list, as known by those of skill in the art.

At 208, the third or correlation server 116 ranks the first potential destination and the second potential destination. The ranking is based on a comparison between the first network performance metric and the second network performance metric. Specifically, the correlation server 116 increases the recommendation priority of the higher ranked potential destination, and lowers the recommendation priority of the lower ranked potential destination. In addition, the ranking of the first potential destination and the second potential destination can be based on at least one of a customer review of the first potential destination and the second potential destination, a security level at the potential first destination and the second potential destination, and a historical safety metric of a preferred route to the first potential destination and the second potential destination. For example, the ranking of the first potential destination and the second potential destination may take into account the number of negative customer reviews received for the destinations.

Similarly, the ranking may take into account the security levels at each destination (i.e., the security of the network, whether the first potential destination and the second destination have been the victim of a security hack), safety records (i.e., number of break-ins near or at the first potential destination and the second potential destination) of the destinations, or the safety of the routes to each of the destinations (i.e., number of traffic accidents near or at the first potential destination and the second potential destination). Such additional data can be retrieved from the first server 112; for example, the navigation server may include applications that provide customer reviews, safety information (either input by users or from municipality databases, for example), and other destination-related information.

The ranking of the first potential destination and the second potential destination can also be based on an anticipated departure time, a device battery life state, and a need for a renewable energy source. Specifically, if the method 200 is performed at 3:00 pm, but the user does not plan to depart until 5:00 pm, the first and second network performance metrics can be based on the network performance history at 5:00 pm, rather than at the time of the request. Additionally, if the ranking takes into account device battery life (i.e., the device has 25% battery life remaining), the ranking of the first potential destination and the second potential destination may factor in proximity in the ranking, as the user is need of a charging location for the device. Similarly, if the need for a renewable energy source is required (i.e., the device captures solar energy), the ranking of the first potential destination and the second potential destination may factor in a route with more access to the sun (i.e., less tunnels, less shaded routes).

At 210, the method 200 can further include navigating to one of the first potential destination and the second potential destination, based on the ranking. Specifically, the third server 116 can automatically select the destination with the higher ranked performance metric, and communicate the selected destination to the second server 114. The second server 114 can then send instructions to the device 102, navigating the device to the selected destination. Alternatively, the third server 116 can recommend a final destination based on the ranking of the first potential destination and the second potential destination. The recommendation can be sent to the device 102, and a final destination selection can be made by the device user, for example.

In some cases, the user may be utilizing the device 102 at the time of the method 200, and therefore, the method 200 can also include determining if the subscriber is using the device, and if the subscriber is using the device, automatically selecting and navigating to a final destination based on the ranking of the first potential destination and the second potential destination. For example, the third server 116 can determine if the user/subscriber is on a voice call, connected to another device, or if the subscriber is accessing a data or a video service. Such automated functionality can increase user efficiency, as they are not required to stop what they are doing to select the higher ranked destination. Similarly, the method 200 can be configured such that if the user is operating a vehicle and utilizing the in-vehicle navigation device, the third server 116 can automatically select the final destination and send the selection to the second server 114, which can then navigate the user to the destination. Such a feature can be implemented as a user setting or as a safety feature offered by an operator or service provider, for example.

In accordance with the method 200, the correlation or third server 116 can be further configured to compute a KPI, such as a degree to which the navigating was modified in response to the first and second network performance metrics. The computed KPI can then be displayed to the end user or subscriber for their information. Alternatively or in addition to displaying the computed KPI to the user, the computed KPI can be shared with, for example, the first server, the second server, a wireless network provider, an operations and maintenance server, the first destination, the second destination, and the device. Such a KPI may also be useful to merchants/service providers/municipalities corresponding to the first and second destinations, as it can provide a quantitative measurement regarding the users who select the destination based on the higher ranked performance metric. Such knowledge could motivate the merchants to upgrade their communication network, for example, in the hopes of increasing the number of users that select their respective destination. In one example embodiment, this may result in the automated deployment of additional wireless resources to that destination. Furthermore, this automated deployment could comprise automatically deploying one or more wireless technologies to that destination area and may comprise utilizing at least one of: wireless drones, self driving vehicles, satellite, low earth satellite/balloon technology, and physically delivering additional wireless infrastructure to that geographic area. Additionally, such KPI knowledge could also cause municipalities to add more access points to their networks, which can increase the network performance metrics of their respective destinations, and thereby increase the number of users who select destinations related to the municipality.

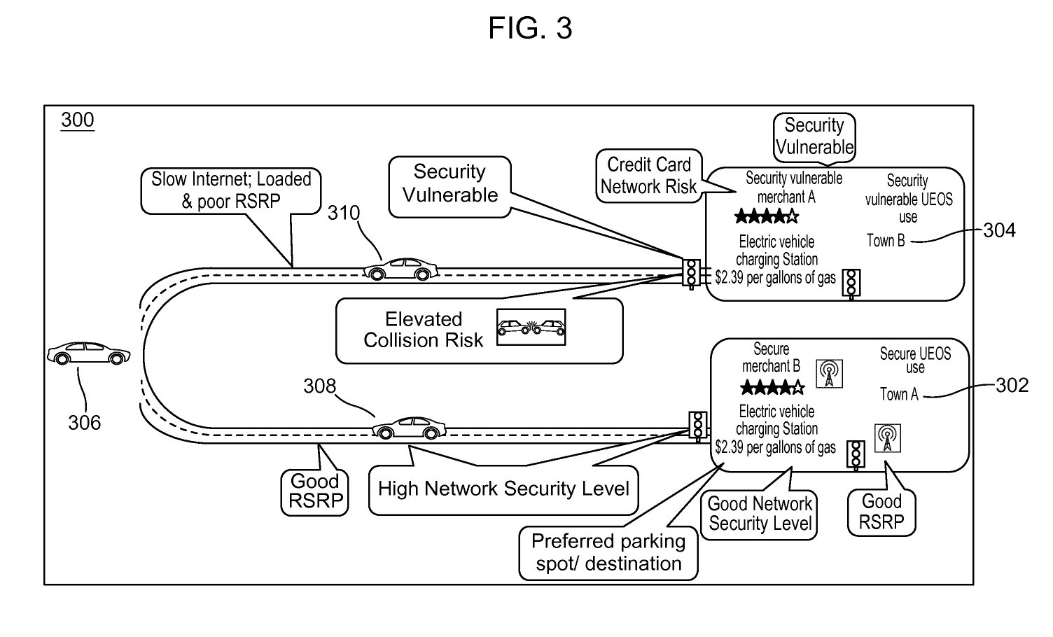

To further explain the system 100 and the method 200 of the present disclosure, FIGS. 3-7 will now be discussed, each of which depicts an example use case in accordance with the present disclosure. FIG. 3 illustrates a use case 300 in which the first potential destination and the second potential destination are gas stations. In the use case 300, the first potential destination is indicated as Town A 302, and the second potential destination is indicated as Town B 304. The user 306 has selected Towns A and B as potential destinations in the navigation server. Based on these selections, the network knowledge server can communicate with locations in Towns A and B (i.e., the gas station in each town, businesses near each gas station, connected cars in the vicinity of Towns A and B) to determine the performance metrics associated with Towns A and B. For example, the network knowledge server determines that Town A provides “good RSRP” and “good network security level”, and further determines from a vehicle 308 that Town A provides “high network security levels”. Similarly, the network knowledge server determines that Town B provides “credit card network risk” and “vulnerable security”, and receives communication from vehicle 310 that the route to Town B has an “elevated collision risk”.

The network knowledge server sends the various performance metrics to the correlation server, which then analyzes the metrics and ranks Town A relative to Town B, based on the metrics. In use case 300, the correlation server will recommend that the user select Town A to purchase their gas, based on the network performance metrics associated with Town A.

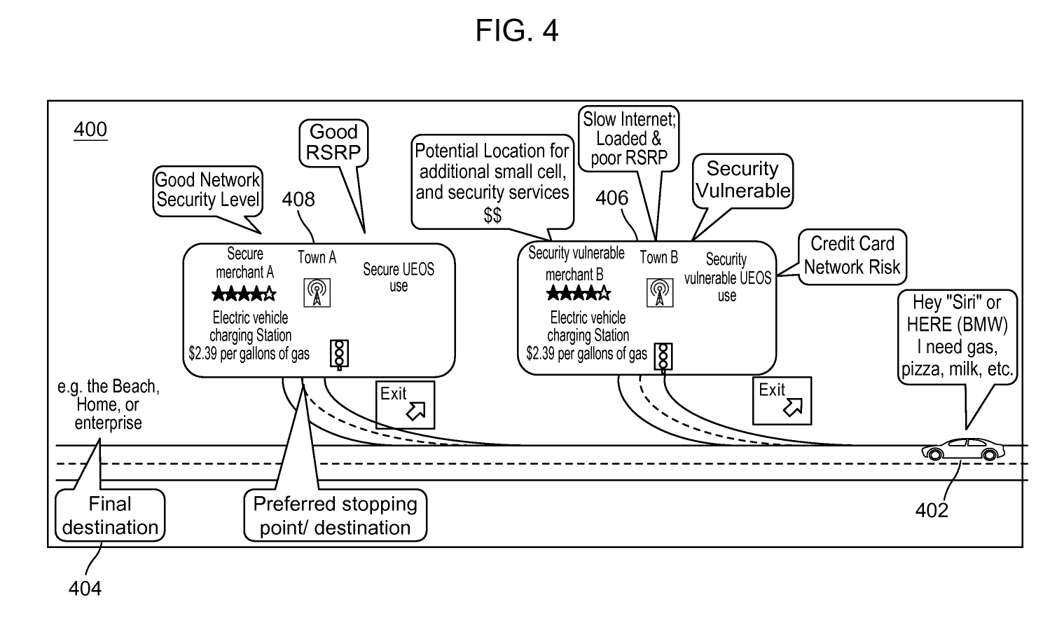

FIG. 4 illustrates a use case 400 in which a user/vehicle 402 is en route to a final destination 404, but wishes to stop for gas/food prior to their arrival at the final destination. In use case 400, Town B 406 can be the first potential destination, and Town A 408 can be the second potential destination, based on proximity to the user 402. The navigation server can automatically select Towns A and B as potential destinations based on their proximity to the user, and/or based on the needs of the user (i.e., gas, food, groceries). Once the potential destinations are known, the network knowledge server can begin compiling the performance metrics related to Towns A and B. In use case 400, Town B has a “credit card network risk”, “security vulnerability”, and “slow internet”. Town A, on the other hand, has “good RSRP” and a “good network security level”.

Based on these performance metrics, the correlation server ranks Town A relative to Town B, and sends a recommendation to the user (or automatically selects the higher-ranked town as the final destination). In use case 400, it is clear that the user will select Town A as the preferred destination, even though it is further away from the user's current location. The correlation server could send this data to Town B directly (i.e., to the municipality or service provider of Town B), informing Town B that users are bypassing their town due to these security and network performance issues. Such information could be helpful to Town B and motivate the municipality to upgrade their network/security services, as there may be a loss of profits related to the fact that some users are driving past Town B due to its poor network services, even if it may be in closer proximity to the user.

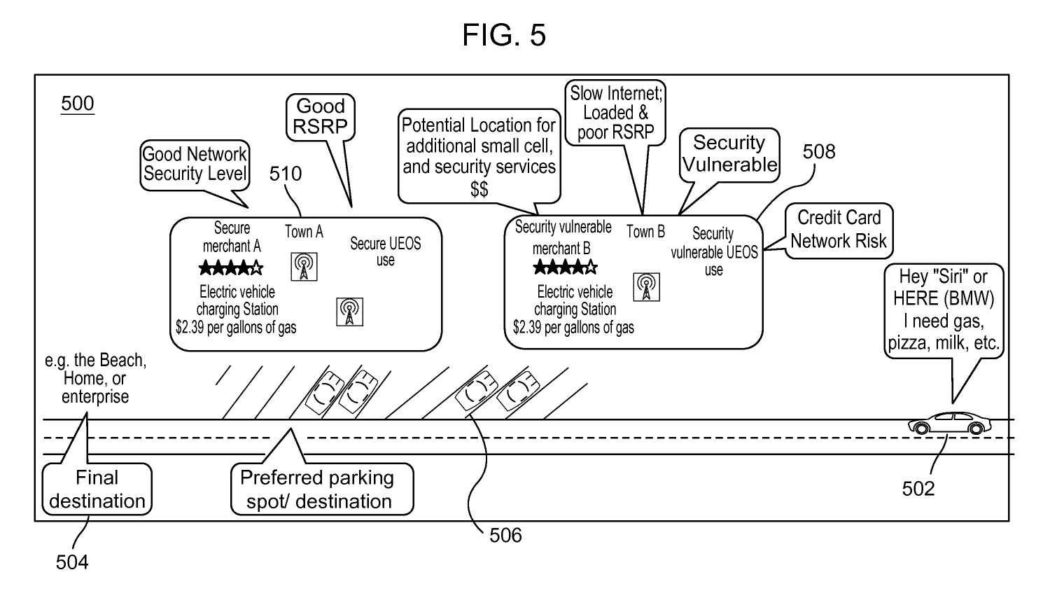

FIG. 5 illustrates a use case 500, in which a user 502 is en route to a final destination 504, but wishes to stop for at a restaurant prior to the final destination. In use case 500, the user 502 is interested in finding a parking spot 506 closest to the restaurant. This may be a helpful scenario in cases of inclement weather, for example, where the user does not wish to walk far to arrive at their destination. The navigation server can select first potential destination Town B 508 and second potential destination Town A 510 based on the user's location and/or preferences. The network knowledge server can then monitor the network performance metrics associated with Town A and Town B. For example, the network knowledge server can determine that Town B 508 poses a “credit card network risk”, has “vulnerable security”, and “slow Internet”. The network knowledge server can also determine that Town A 510 has “good RSRP” and a “good network security level”, for example. Based on these performance metrics, the correlation server can rank Town A relative to Town B, and either recommend or select the destination with the higher ranking, which in this scenario is Town A. The navigation server can then find a parking spot in close proximity to the desired location within Town A, for example, and navigate the user to that particular spot, for example.

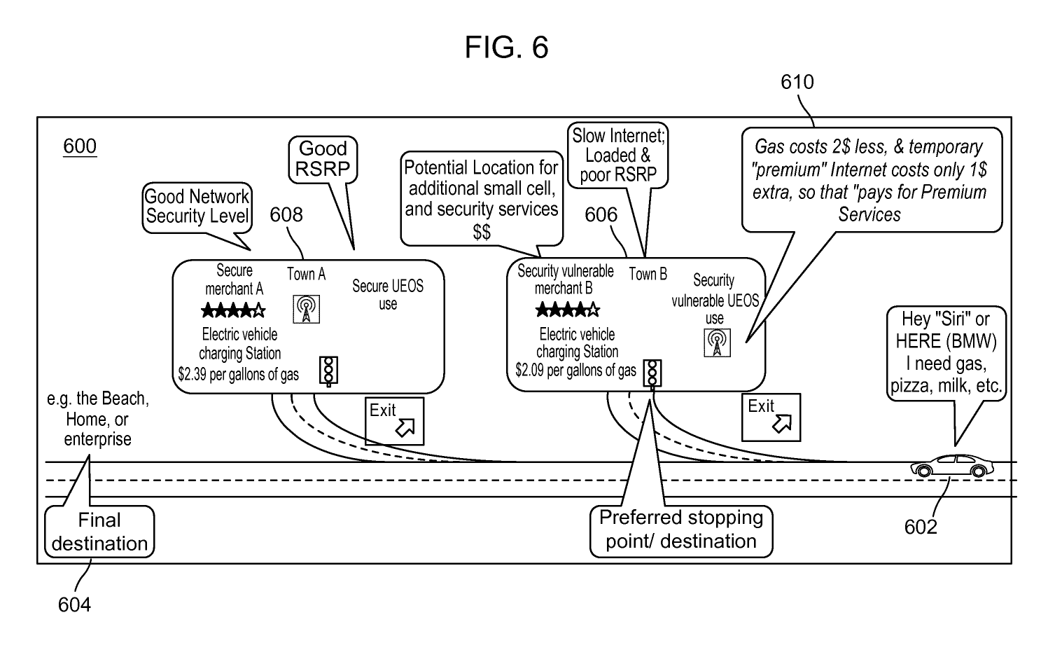

Referring now to FIG. 6, a further use case 600 illustrates a user 602 traveling to a final destination 604, but who needs to stop for gas prior to arriving at the final destination. The navigation server can provide the user 602 with a first potential destination Town B 606 and a second potential destination Town A 608, each of which offers a gas station. The navigation server can also provide additional information to the user regarding the respective gas station in each town. For example, the navigation server can include information regarding gas station B 610, such as “gas costs $0.25 less per gallon than gas station A 612 in Town A”. The network knowledge server can provide first and second performance metrics related to Towns B and A, respectively. For example, in use case 600, Town B 606 provides “slow Internet” and “poor RSRP”, with the ability to upgrade to better Internet performance for “$1.00 extra”. Town A 608 provides “good RSRP” and a “good network security level”, but higher gas prices compared to gas station B 610 in Town B 606.

The correlation server will take all of this information into account and rank gas stations A and B based on the information from the navigation server and the information from the network knowledge server, and provide a recommendation to the user 602. In the present use case 600, the user 602 has selected Town B as the preferred stopping point, even though the Internet services are not as powerful as that of gas station A 612 in Town A 608. In this case, the correlation server may have recommended Town A 608 to the user 602, due to the improved network security level and RSRP, but the user may have decided that lower gas prices are more important than improved network services.

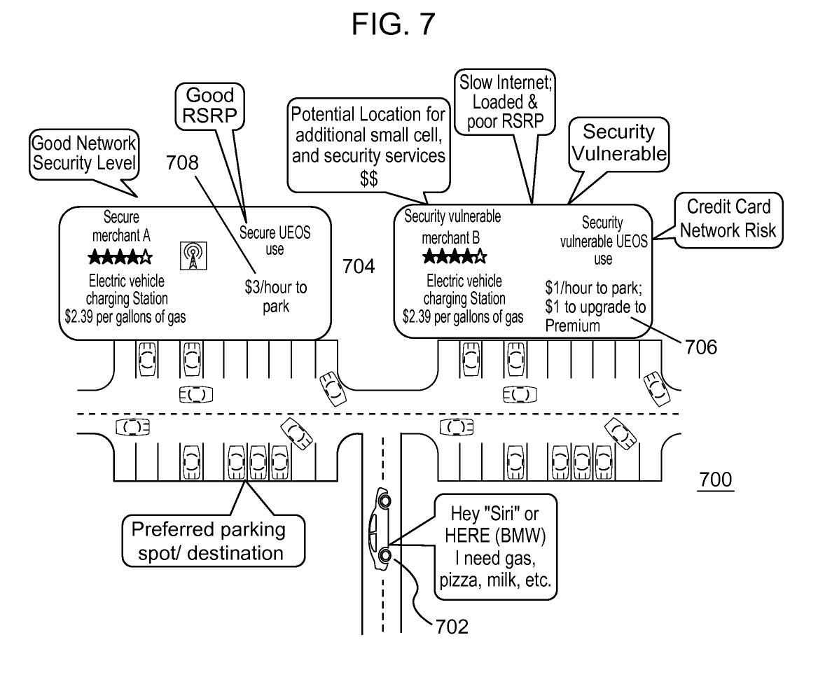

FIG. 7 illustrates a use case 700 in which a user 702 is looking for a car charging station in Town A 704. The navigation server alerts the user 702 to two potential car charging stations in Town A, charging station A 706 and charging station B 708. As seen in FIG. 7, the car charging stations are in close proximity to each other, but parking at car charging station A 706 is $2.00 less per hour. The network knowledge server monitors and provides the user 702 with first and second performance metrics related to car charging stations A and B, respectively. In use case 700, car charging station A 706 provides “slow Internet” and “poor RSRP”, but offers the user the ability to upgrade to “Premium Internet” for $1.00 per hour. Car charging station B 708 provides “good RSRP” and a “good network security level”.

The correlation server receives the information from the navigation server and the network knowledge server and ranks car charging station A 706 relative to car charging station B 708, and provides a recommendation to the user 702 based on the ranking. In this use case 700, car charging station A 706 may be ranked higher than car charging station B 708, even though the network performance metric for station A may be better than that of station B. This is because the correlation server can also take into account the cost to park at the charging stations, as well as the cost to upgrade to premium Internet services at the charging stations, if applicable. Alternatively, the correlation server may rank charging station B 708 higher than charging station A 706 due to station A's poor network performance, but the user 702 may ultimately decide that they would rather pay less for parking and pay for the Internet upgrade, therefore choosing station A as their preferred destination. It is appreciated that if the correlation server makes a recommendation to the user, the user is not required to accept such a recommendation; similarly, if the correlation automatically selects the destination for the user, the user can override the selection or start the search over with additional criteria, if necessary.

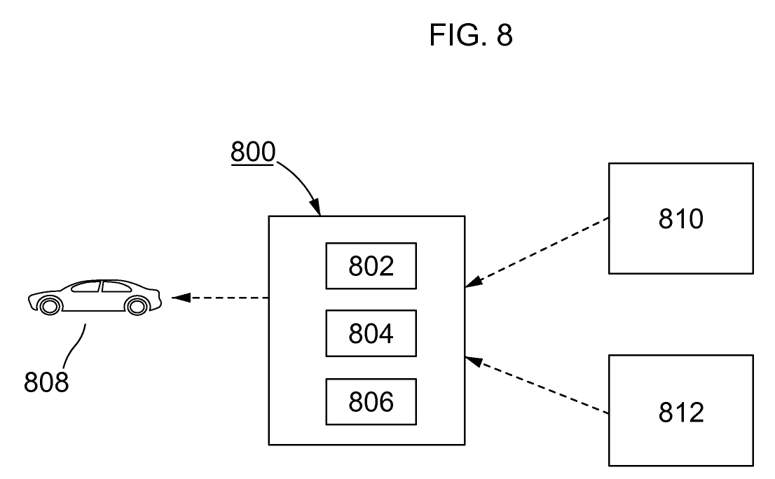

Referring now to FIG. 8, an apparatus 800 is provided in accordance with the present disclosure. The apparatus 800 includes a memory 802, a processor 804, and at least one database 806. The apparatus 800 is in communication with a subscriber device 808, a first server 810, and a second server 812. The subscriber device 808 is similar to the device 102 in system 100, and it can include a memory, a processor, and a display, for example (not shown). The device 808 can be a mobile device such as a cellular phone, or it can be a vehicle with connected car abilities, for example. The first server 810 can be a navigation server similar to the navigation server 112 in system 100. Further, the second server 812 can be a network knowledge server, similar to the network knowledge server 114 in system 100. The apparatus 800 can be a correlation server, similar to the correlation server 116 in system 100. As described above, the apparatus 800 can be a standalone server or part of a component in a communication network.

The apparatus 800 can receive a first potential destination and a second potential destination from the first server 810. The apparatus 800 can also receive a first network performance metric from the second server 812, and a second network performance metric from the second server. The first network performance metric and the second network performance metric can include at least one performance metric related to the respective destination and/or surrounding vicinity. Similar to the method 200, the first network performance metric corresponds to the first potential destination, and the second network performance metric corresponds to the second potential destination. For example, the first and second performance metrics can correspond directly to the destination (i.e., a gas station or coffee house), to businesses in the vicinity of the destination, or to the municipality in which the destination is located (i.e., network performance statistics of the municipality as a whole, wireless/streaming features provided by the municipality). The apparatus 800 can then rank the first potential destination relative to the second potential destination, based on a comparison between the first network performance metric and the second network performance metric. Although not required, the apparatus 800 can automatically select one of the first potential destination and the second potential destination, and instruct the second server to navigate the device to the selected destination.

The present disclosure provides a system, method, and apparatus for destination recommendation and selection that takes into account network performance metrics at potential destinations when providing the recommendation. Network performance metrics related to each potential destination are received at the correlation server, along with any additional information received from the navigation server (i.e., customer reviews, price statistics), for example, and each potential destination is then ranked based on this information. The correlation server can then recommend a final destination to the user based on the ranking, or automatically select the final destination for the user based on the ranking. In this way, users who require high Internet performance or premium Internet services can select their preferred destination based on more than just the proximity of the destination to their current location. Accordingly, the present system, method, and apparatus takes into account a user's wireless communication needs, in addition to their destination requests (i.e., fast food, coffee, gas station).

The present disclosure can also benefit municipalities and/or businesses within the potential destinations ranked by the correlation server. For example, the correlation server can provide a business with KPIs or statistics regarding the number/frequency of users who select other businesses/destinations because of better wireless network performance. Such knowledge may motivate the business/municipality to offer premium Internet services or upgrade to an improved wireless service provider/network.

Embodiments of the present disclosure may be implemented in software (executed by one or more processors), hardware (e.g., an application specific integrated circuit), or a combination of software and hardware. In an example embodiment, the correlation server may include software (e.g., application logic, an instruction set) that is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present disclosure can include a computer program product comprising a computer-readable storage medium bearing computer program code embodied therein for use with a computer, the computer program code comprising code for performing any of the methods and variations thereof as previously described. Further, the present disclosure can also include an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the disclosure are set out in the independent claims, other aspects of the disclosure comprise other combinations of features from the described embodiments and/or the dependent claims with the features of the independent claims, and not solely the combinations explicitly set out in the claims.

It is also noted herein that while the above describes example embodiments of the disclosure, these descriptions should not be viewed in a limiting sense. Rather, there are several variations and modifications which may be made without departing from the scope of the present invention as defined in the appended claims.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the invention. In order to determine the metes and bounds of the disclosure, therefore, reference should be made to the appended claims. The following abbreviations that may be found in the specification and/or the drawing figures are defined as follows:
KPI Key Performance Indicator
RSRP Reference Signal Received Power
V2I Vehicle-to-Internet

1.-27. (canceled)

28. A method, comprising:
at a first server, determining a first potential destination and a second potential destination;
at a second server, determining a first network performance metric corresponding to the first potential destination;
at the second server, determining a second network performance metric corresponding to the second potential destination;
at a third server, ranking the first potential destination and the second potential destination, wherein the ranking is based on a comparison between the first network performance metric and the second network performance metric.

29. The method of claim 28, further including navigating, on a device having a memory, a processor, and a display, to one of the first potential destination and the second potential destination, based on the ranking.

30. The method of claim 28, wherein the first server is a navigation server configured for navigating one of the first potential destination and the second potential destination.

31. The method of claim 28, further including, at the third server, recommending a final destination based on the ranking of the first potential destination and the second potential destination.

32. The method of claim 31, further including:
determining if the subscriber is using the device; and
if the subscriber is using the device, automatically selecting and navigating to a final destination based on the ranking of the first potential destination and the second potential destination.

33. The method of claim 32, wherein determining if the subscriber is using the device includes at least one of: determining if the subscriber is on a voice call; determining if the subscriber is connected to another device; determining if the subscriber is accessing a data or a video service.

34. The method of claim 28, wherein ranking the first potential destination and the second potential destination is further based on at least one of a customer review of the first potential destination and the second potential destination, a security level at the potential first destination and the second potential destination, and a historical safety metric of a preferred route to the first potential destination and the second potential destination.

35. The method of claim 29, wherein the third server is further configured to compute a key performance indicator, KPI, the KPI being a degree to which the navigating was modified in response to the first and second network performance metrics, wherein the computed KPI is configured to be at least one of: displayed to an end user and shared with at least one of the first server, the second server, a wireless network provider, an operations and maintenance server, the first destination, the second destination, and the device; and a trigger for the automated delivery of additional wireless infrastructure to that potential destination.

36. A system, comprising:
at least one device having a memory, a processor, and a display, the device connected to a network;
a first server configured for communicating with the device;
a second server configured for communicating with the device; and
a third server in communication with the first server and the second server; wherein the third server is configured to:
receive a first potential destination and a second potential destination from the first server;
receive a first network performance metric from the second server, the first network performance metric corresponding to the first potential destination;
receive a second network performance metric from the second server, the second network performance metric corresponding to the second potential destination; and
rank the first potential destination relative to the second potential destination, based on a comparison between the first network performance metric and the second network performance metric.

37. The system of claim 36, wherein the first network performance metric of the first potential destination and the second network performance metric of the second potential destination are greater than a predetermined network performance metric threshold.

38. The system of claim 36, wherein the first potential destination and the second potential destination include at least one of video viewing capability, a security level above a predetermined threshold, and a preferred service provider.

39. The system of claim 36, wherein the first server is a navigation server having a memory and a processor, the navigation server configured for providing GPS data, navigation data, and routing data relative to the first potential destination and the second potential destination.

40. The system of claim 36, wherein the second server is a network knowledge server having a memory and a processor, and being configured for providing network performance metrics to the third server.

41. The system of claim 36, wherein the third server is a correlation server having a memory, at least one database, and a processor, the correlation server being configured to rank the first potential destination and the second potential destination, to store the ranking, and to recommend a higher ranked one of the first potential destination and the second potential destination.

42. The system of claim 41, wherein the correlation server is further configured to automatically select one of the first potential destination and the second potential destination, and to instruct the second server to navigate the device to the selected destination.

43. An apparatus, comprising:
a memory;
a processor; and
at least one database;
wherein the apparatus is in communication with a subscriber device, a first server and a second server;
wherein the apparatus is configured to:
receive a first potential destination and a second potential destination from the first server;
receive a first network performance metric from the second server, the first network performance metric corresponding to the first potential destination;
receive a second network performance metric from the second server, the second network performance metric corresponding to the second potential destination; and
rank the first potential destination relative to the second potential destination, based on a comparison between the first network performance metric and the second network performance metric.

44. The apparatus of claim 43, wherein the apparatus is further configured to store the ranking, and to recommend a higher ranked one of the first potential destination and the second potential destination.

45. The apparatus of claim 43, wherein the apparatus is further configured to automatically select one of the first potential destination and the second potential destination, and to instruct the second server to navigate the device to the selected destination.
